(19) United States
(12) Patent Application Publication
(10) Pub. No.: US 2018/0330435 A1
(43) Pub. Date: Nov. 15, 2018

(54) METHOD FOR MONITORING AND SUPPORTING AGRICULTURAL ENTITIES

(71) Applicant: Harvesting Inc., Fremont, CA (US)

(72) Inventor: Ruchit Garg, Fremont, CA (US)

(21) Appl. No.: 15/978,037

(22) Filed: May 11, 2018

Related U.S. Application Data
(60) Provisional application No. 62/504,704, filed on May 11, 2017.

(51) Int. Cl. G06Q 40/02; G06Q 50/02; G06Q 30/02; G06F 17/30; G06T 7/11

(52) U.S. Cl. CPC G06Q 40/025; G06Q 50/02; G06Q 30/0283; G06T 2207/10032; G06T 7/11; G06T 2207/30188; G06F 17/30241

(57) ABSTRACT

One variation of a method for monitoring and supporting agricultural entities includes: accessing a loan application identifying a farm; accessing a satellite image representing a geographic region in which the farm is located; extracting a set of features from a region of interest—corresponding to the farm—in the satellite image; based on the set of features, identifying a crop present on the farm, estimating a land area of the crop on the farm, and estimating a yield per unit land area of the crop on the farm; accessing a production cost per unit land area planted and a market price of the crop in the geographic region; and estimating a productivity score of the farm based on the yield per unit land area, the production cost per unit land area, the market price, and the land area of the crop on the farm.

### CROSS-REFERENCE TO RELATED APPLICATIONS

This Application claims the benefit of U.S. Provisional Application No. 62/504,704, filed on 11 May 2017, which is incorporated in its entirety by this reference.

### TECHNICAL FIELD

This invention relates generally to the field of agriculture and more specifically to a new and useful method for monitoring and supporting agricultural entities in the field of agriculture.

### BRIEF DESCRIPTION OF THE FIGURES

FIG. 1 is a flowchart representation of a method;

FIG. 2 is a flowchart representation of the method; and

FIG. 3 is a flowchart representation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

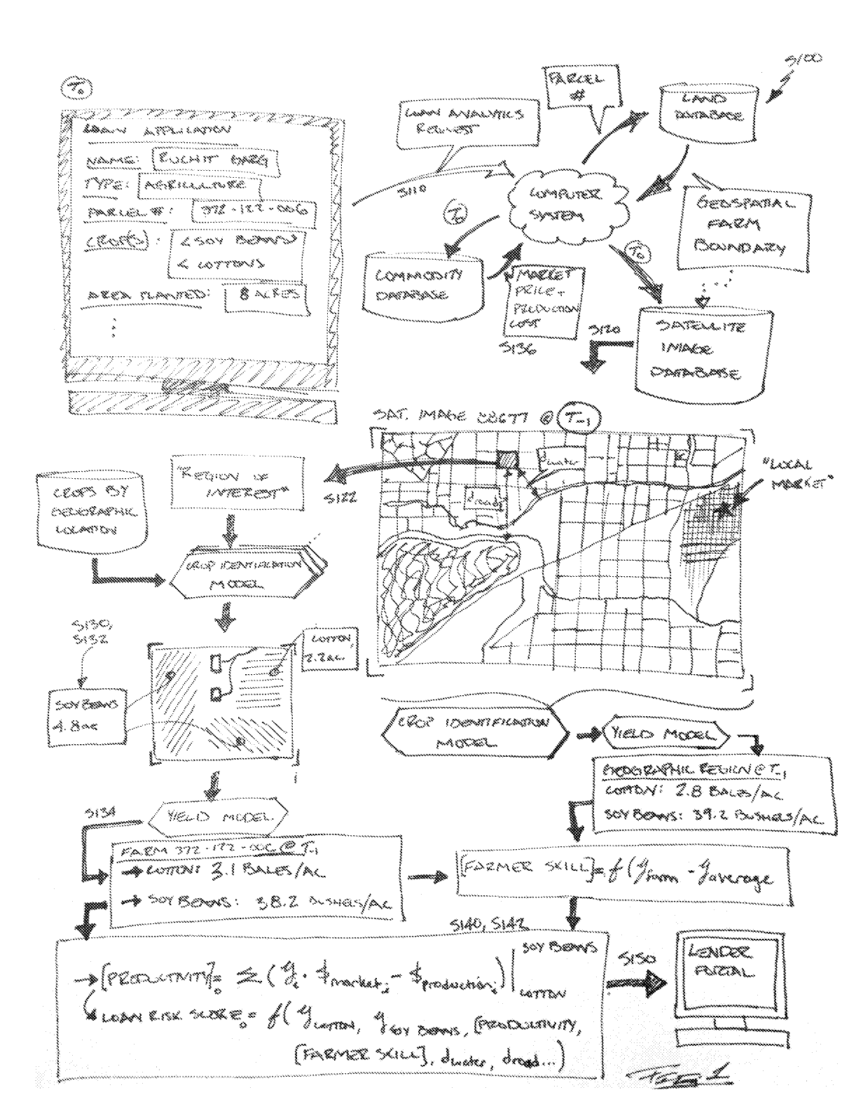

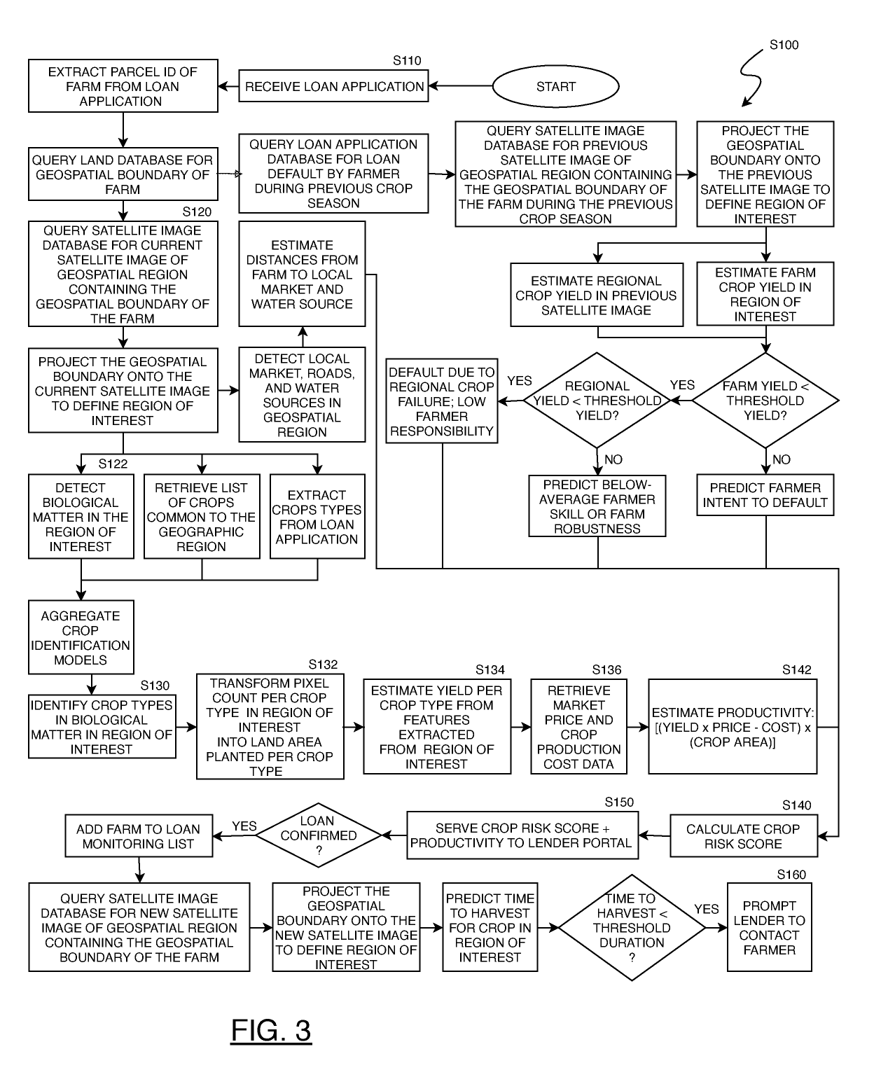

As shown in FIGS. 1 and 3, a method S100 for monitoring and supporting agricultural entities includes: accessing a loan application identifying a first farm and submitted by a user at a first time in Block Silo; accessing a first satellite image representing a geographic region in which the first farm is located, the first satellite image recorded near the first time in Block S120; extracting a first set of features from a first region of interest in the first satellite image in Block S122, the first region of interest corresponding to the first farm identified by the first loan application; based on the first set of features, identifying a first crop present on the first farm in Block S130, estimating a first land area of the first crop present on the first farm in Block S132, estimating a first yield per unit land area of the first crop present on the first farm in Block S134, and generating a loan risk score for the first loan application in Block S140; accessing a first production cost per unit land area of the first crop planted and a first market price of the first crop in the geographic region in Block S136; estimating a first productivity score of the first farm based on the first yield per unit land area, the first production cost per unit land area, the first market price, and the first land area of the first crop present on the first farm in Block S142; and returning the loan risk score and the first productivity score to the user at approximately the first time in Block S150.

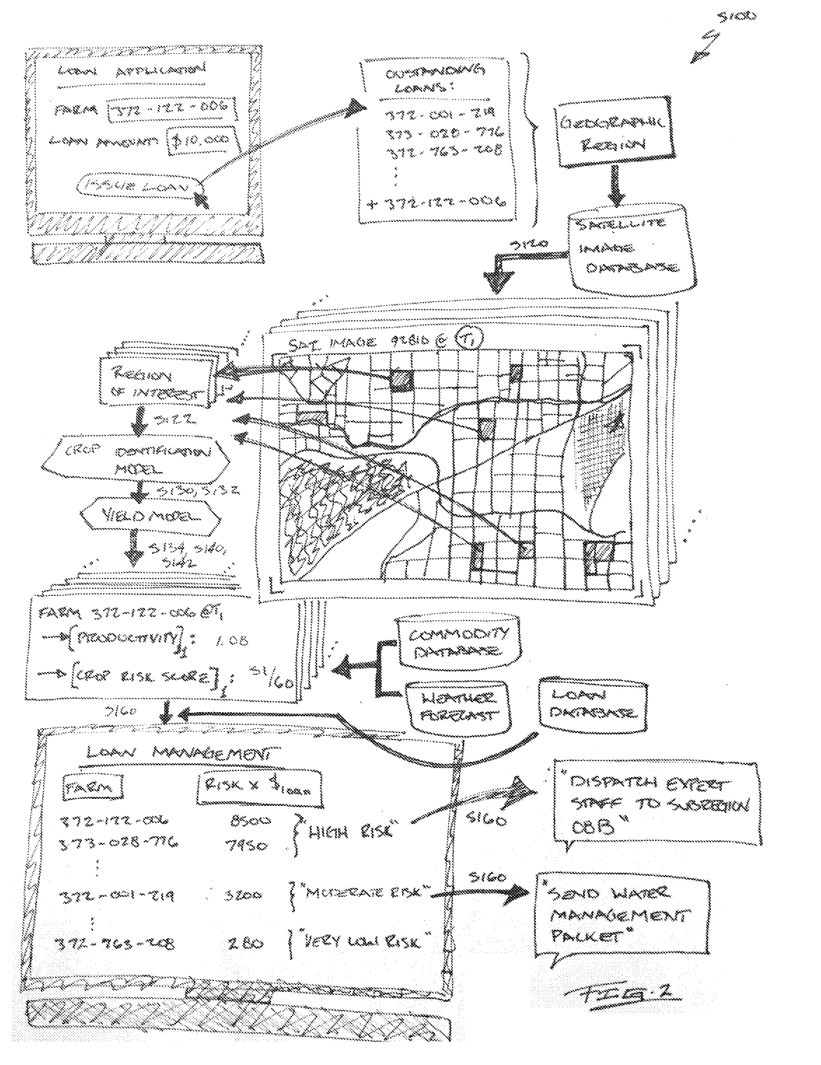

As shown in FIGS. 1, 2, and 3, one variation of the method S100 includes: accessing a first loan application identifying a first farm, indicating a first loan amount, and submitted by a user at a first time in Block Silo; accessing a first satellite image representing a geographic region in which the first farm is located in Block S120, the first satellite image recorded near the first time; extracting a first set of features from a first region of interest in the first satellite image in Block S122, the first region of interest corresponding to the first farm identified by the first loan application; based on the first set of features, identifying a first crop present on the first farm in Block S130 and estimating a first yield of the first crop present on the first farm in Block S134; based on the first crop and the first estimated yield, generating a loan risk score for the first loan application in Block S140; returning the loan risk score to the user in Block S150; in response to confirmation of the first loan application by a lender, accessing a second series of satellite images representing the geographic region and recorded over a second period of time succeeding the first time in Block S120; for each satellite image in the second series of satellite images, extracting a second set of features from a second region of interest in the second satellite image, the second region of interest corresponding to the first farm identified by the first loan application in Block S122, based on the second set of features, generating a second estimated yield of the first crop present on the first farm in Block S134, and generating a first crop risk score for the first farm in Block S160; and, in response to the first crop risk score exceeding a threshold score, serving a prompt to the lender to selectively contact the first farm in Block S152.

As shown in FIGS. 1 and 3, another variation of the method S100 includes: accessing a loan application identifying a farm and submitted by a user in Block S110; accessing a satellite image representing a geographic region in which the farm is located in Block S120; extracting a set of features from a region of interest in the satellite image, the region of interest corresponding to the farm identified by the loan application in Block S122; based on the set of features, identifying a crop present on the farm in Block S130, estimating a land area of the crop present on the farm in Block S132, and estimating a yield per unit land area of the crop present on the farm in Block S134; accessing a production cost per unit land area of the crop planted and a market price of the crop in the geographic region in Block S136; estimating a productivity score of the farm based on the yield per unit land area, the production cost per unit land area, the market price, and the land area of the crop present on the farm in Block S142; and returning the productivity score to the user in Block S150.

### 2. Applications

Generally, the method S100 can be executed by a local or remote computer system (hereinafter the “system”): to intake agricultural loan application data identifying agricultural land (hereinafter a “farm”); to retrieve remote sensing data representing the farm and the geographic region in which the farm is location from various external sources; to derive absolute and relative characteristics of the farm from these remote sensing data; and to calculate a risk of loan repayment for a loan issued to the farm based on these characteristics of the farm—such as rather than or in addition to financial history of the farm or a farmer associated with the farm. In particular, the system can automatically execute Blocks of the method S100 to: collect minimal loan application data for a farmer requesting an agricultural loan for a farm from a lending institution or bank (hereinafter the “lender”); retrieve remote sensing data from various external sources (e.g., a land database, a weather forecast and historical weather database, a commodities market database, and a satellite and/or aerial image database); and to transform these data into a quantitative or qualitative representation of loan repayment risk (hereinafter a “loan risk score”) based on actual current, historical, and forecast agricultural yield and productivity of the farm. The system can then serve this loan risk score to an associate of the lender in near real-time, which may enable the associate to quickly make an informed loan decision that accounts for: absolute and relative quality of crops currently growing on the farm and elsewhere in the geographic region; the farmer's skill; the farmer's experience growing these crops; the farm's robustness to weather and climate events; effects of past weather and climate events on crop yield on the farm; current and/or forecast market conditions; and proximity of the farm to a market and road conditions therebetween; all of which may affect crop yield at harvest, farm production costs, farm revenues, and thus the farmer's capacity to repay a loan following the conclusion of the current crop season.

For example, the system can interface with a loan officer associated with the lender via a lender portal accessed through a web browser or native application executing on a computing device (e.g., a desktop computer or tablet) to receive loan information for a farmer inquiring over an agricultural loan from the lender. The system can then extract farm identification information from this loan application and query a land database for a geospatial boundary of the farmer's farm (e.g., in the form of a set of geospatial vertices) based on these farm identification information. Based on this geospatial boundary of the farm, the system can query an aerial imagery database for a most-recent satellite image (or aerial image) of a geographic region containing this geospatial boundary and project the geospatial boundary onto this satellite image to isolate a region of interest corresponding to the farm. The system can then implement computer vision (e.g., feature extraction, object recognition, template matching) and/or artificial intelligence techniques (e.g., neural networks) to extract various quantitative and qualitative data from this region of interest, such as: type of crop planted; land area of the crop planted; predicted yield of this crop; crop quality; and soil moisture and temperature. The system can also identify a local market and calculate a distance from the farm to the local market by extracting these data directly from the satellite image and/or by querying another database, such as a map database and local market database. The system can extract similar quantitative and qualitative agricultural data from other regions of the satellite image and then compare these agricultural data to data extracted from the region of interest corresponding to the farm to derive relative qualities of the farm, such as whether the farm is producing greater or lesser yield or producing higher- or lower-quality crops than neighboring farms. Furthermore, the system can: query the aerial imagery database for historical satellite images of the geographic region; extract similar quantitative and qualitative agricultural data from these historical satellite images; and then derive trends in yield and crop quality, land robustness to weather and climate events, farmer experience, etc. for the farm and for the geographic region more generally. The system can therefore extract a variety of historical, current, and forecast crop yield data from satellite images of the geographic region in which the farm—indicated in the loan application—is located and then contextualize these crop yield data with other market, weather, map, loan history, and/or other available data for the geographic region.

In this example, the system can also: multiply the estimated absolute (or relative) yield per unit land area of the crop planted for the farm by the total land area of the crop planted to determine an absolute yield of the farm; multiply absolute yield of the farm by a current or forecast market price of the crop to estimate total revenue from this crop for the farm; divide this estimated total revenue by a product of the total land area of the crop planted on the farm and the estimated production cost per unit land area of the crop planted in the geographic region; and store this value as a productivity (e.g., an output-to-input ratio) of the farm for this crop. The system can then generate a loan risk score that represents: the estimated productivity of the farm; the estimated absolute yield of the farm and/or yield relative to other farms in the geographic region; farmer experience; farm robustness; and other metrics extracted from satellite images of the geographic region and contextualizing data from other sources. The system can then serve both the loan risk score and the estimated productivity for the farm to the loan officer, such as in near real-time through the lender portal.

Based on these metrics generated and provided to the lender by the system according to the method S100, the lender may thus increase its rate of loan acceptance while also reducing likelihood of default by accounting for variables substantially likely to affect loan repayment by farmers (i.e., yield, market price, production costs, marketing opportunity, local and regional agricultural history, etc.). More specifically, the system can execute Blocks of the method S100 to derive a “creditworthiness” of a farmer based on actual historical, current, and forecast characteristics and outcomes of the farmer's farm derived from remote sensing data, such as satellite images (and/or aerial images) of the farm.

To further enable the lender to reduce likelihood of default on agricultural loans issued by the lender, the system can implement similar methods and techniques to: access new satellite images of a geographic region containing farms to which the lender holds outstanding loans; calculate new absolute and relative yield estimates, yield trends, etc. for these farms based on features detected in these new satellite images; and then selectively prompt the lender to provide additional resources and support to specific farms exhibiting lower estimated yields or higher risk of crop failure, such as additional educational materials or remote or in-person discussions with agricultural specialists.

### 3. System and Images

The method S100 is described below as executed remotely from a lender, such as by a remote server or computer network. However, Blocks of the method S100 can be executed by any other local or remote computer system. The system is described herein as interfacing with a loan officer via a lender portal—such as accessed through a web browser or native application executing on a desktop or mobile computing device—to collect loan application data for a farm or farmer. However, the system can alternatively interface with a farmer directly to collect loan application data, such as through a borrower portal accessed through the farmer's cellular phone or smartphone. The system is also described herein as returning a loan risk score, an estimated productivity, and/or selective prompts for loan support to the loan officer via the lender portal in order to support the loan officer in completing loan decisions and reducing default rate for outstanding loans.

However, the system can alternatively finalize a decision for a loan application for a farmer automatically on behalf of a lender, such as based on metrics thus derived by the system and based on preset rules or a preset loan acceptance model defined or adjusted by the lender. Furthermore, the system can also automatically set a loan amount for such a loan based on a loan risk score and an estimated productivity of the farm thus derived by the system. The system can then return a loan application decision and loan details to the farmer in (near) real-time via the borrow portal.

Blocks of the method S100 are described herein as executed by the system to access and extract agriculture-related metrics from a satellite image of a geographic region in which a particular farm is located in order to automatically generate a loan risk score and to automatically predict a productivity of the farm. However, the system can also analyze many discrete satellite images of a contiguous geographic region—recorded at similar times—to derive these agriculture-related metrics. The system can additionally or alternatively analyze a composite satellite image containing many discrete satellite images stitched together in order to derive these metrics. Furthermore, the system can access and analyze other types of aerial images, such as aerial images recorded by manned or unmanned low- or high-altitude aerial vehicles.

### 4. Initial Loan Information

Block S110 of the method S100 recites accessing a loan application identifying a first farm and submitted by a user at a first time. Generally, in Block Silo, the system can access initial data for a new loan application for a farm or farmer.

In one implementation shown in FIG. 1, a loan officer interfaces with a farmer—such as in person—to populate an electronic loan application form with various farmer and farm information, such as: the farmer's name; the farmer's age; a farm identifier (e.g., a plot number, a parcel number, a parcel identifier, a land survey identifier, or an address) of the farm; a list of crop types currently planted or proposed for the farm; an approximate land area planted for each crop; availability of irrigation systems at the farm; and/or presence of a well or access to fresh water at the farm; etc. For example, the loan officer can interface with the farmer to enter these data into a new application form within the lender portal at the loan officer's computing device. Upon completion, the loan officer can submit the new application form to the system for processing according to the method S100.

However, the system can implement any other method or technique to collect these and any other relevant information from the loan officer or the farmer in Block Silo in order to initiate loan application analysis by the system.

### 5. Farm Location

The system can then determine the location of the farm associated with the loan application. In one implementation, the system queries a land database (e.g., a government land management database) for the geospatial location and/or a geospatial boundary of the farm based on the parcel identifier (or other farm identifier) contained in the loan application, shown in FIG. 1. The land database may then return to the system geospatial latitude and longitude coordinates of a geospatial reference point of the farm and a size of the farm (e.g., in acres, hectares). Alternatively, the land database may return to the system geospatial latitude and longitude coordinates of vertices of the land area of the farm; the system can then calculate a polygonal boundary around the farm based on the geospatial coordinates of these vertices and estimate the total land area of the farm accordingly.

Alternatively, if a survey identifier (or plot number, parcel number farm identifier, address) for the farmer's farm is not available, the system can serve a geographic map to the web browser or native application executing on the loan officer's computing device and then prompt the loan officer to manually select three or more vertices—representing the farm—over the map. Upon receipt of these vertices—such as in the form of geospatial latitude and longitude coordinates—the system can calculate a polygonal boundary around the farm based on coordinates of these vertices and estimate the total land area of the farm accordingly.

Yet alternatively, in the absence of an absolute boundary of the farm, the system can: extract an approximate geospatial location of the farm from the loan application; retrieve a satellite image, as described below, representing a geographic region containing this approximate geospatial location; implement computer vision and/or artificial intelligence techniques to identify discrete agricultural “blocks” in the satellite image; identify a particular block in the satellite image that coincides with the approximate geospatial location of the farm; and then interpret the boundary of this particular block as the boundary of the farm. The system can additionally or alternatively interface with the farmer and/or the loan officer to identify one or more blocks in this satellite image as belonging to the farmer's farm.

However, the system can implement any other method or techniques to determine the location of the farm, the size of the farm, etc. The system can then write these farm-related data to the farmer's loan application

### 6. Satellite Images and Region of Interest

Block S120 of the method S100 recites accessing a first satellite image representing a geographic region in which the first farm is located, the first satellite image recorded near the first time. Generally, in Block S120, the system can access satellite image data representing an aerial view of a geographic region in which the geospatial reference point and/or the geospatial boundary of the farm is located.

In one implementation shown in FIG. 1, the system queries a satellite image database for a satellite image encompassing this geographic region containing the geospatial boundary of the farm and recorded nearest the current time (i.e., a most-recent satellite image of the geographic region). For example, the satellite image can include short-wave infrared (or “SWIR”) or color (e.g., “RGB”) optical data of the geographic region. The satellite image can also define a singular discrete satellite image or a composite satellite image containing many discrete satellite images stitched together. Upon receipt of the satellite image, the system can project the geospatial boundary of the first farm onto the satellite image to define a region of interest—corresponding to the farm—in the first satellite image.

Alternatively, the system can query the satellite image database for a cropped area of a discrete or composite satellite image containing the geospatial boundary exclusively; the system can then process this cropped satellite image in subsequent Blocks of the method S100.

Yet alternatively, the system can define the geographic region around the farm and query the satellite image database for a cropped satellite image of this defined geographic region. For example, the system can define the geographic region as a circular area with a radius of 20 miles and centered over the farm. Alternatively, the system can define the geographic region as a geographic area in which the lender is licensed to issue loans.

However, the system can access satellite images (or aerial imagery of any other type) representing a geographic region of any other size or geometry in Block S120.

### 7. Crop Type and Area Planted

Block S122 of the method S100 recites extracting a first set of features from a first region of interest in the first satellite image, wherein the first region of interest corresponds to the first farm identified by the first loan application; Block S130 of the method S100 recites identifying a first crop present on the first farm based on the first set of features; and Block S132 of the method S100 recites estimating a first land area of the first crop present on the first farm based on the first set of features. Generally, the system can detect and extract various features from the satellite image in Block S122 and leverage these features to determine the type of a crop and to estimate the total area of the crop planted on the farm in Block S130 and S132, thereby enabling the system to derive immediate agricultural metrics relevant to the loan application from this singular satellite image of the farm.

In Block S122, the system can implement computer vision techniques to detect and extract features from this region of interest in the satellite image, such as emission spectra (e.g., colors), spectral gradients (e.g., color gradients), and edges (i.e., non-spectral physical features). The system can then implement various models—such as geological and biological models—to classify these features as various object and material types throughout the farm, such as: manmade materials (e.g., metals, plastics, paints, fiberglass, asphalt, oil, chemicals); geological materials (e.g., clays, alteration, iron oxides, carbonates); and biological materials (e.g., trees, grasses, crops). For example, the system can label individual pixels or clusters of pixels in the region of interest of the satellite image as representing manmade, geological, and biological materials, including detecting and labeling a cluster of pixels in the region of interest in the satellite image as likely to represent a crop.

The system can then implement a crop identification model in Block S130 to identify specific types of crops represented in regions of the satellite image labeled as plant matter (e.g., a cluster of pixels in the region of interest labeled as likely to represent a crop). For example, the system can maintain and selectively implement one crop identification model per known or supported crop type, such as one crop identification model for each of: soy beans; maize; wheat; rice; millet; legumes; sugarcane; tobacco; cotton; jute; rapeseed; coffee beans; coconut; tea trees; and/or rubber trees; etc. For example, each crop identification model can define a unique convolutional neural network trained on a corpus of satellite images labeled with geographic areas known to be planted with the corresponding crop. Alternatively, the system can implement a single crop identification model trained on data of many (e.g., dozens, hundreds) of supported crops and configured to output a highest-probability crop for each pixel in the region of interest of the satellite image based on features extracted from the region of interest.

In the foregoing implementations, a crop identification model can also: take a date or time of year as an input; estimate a growth stage of crops in the geographic region based on this time of year and known seasonal variations in this location (e.g., based on whether the farm is in the northern or southern hemisphere); and output a strength of correspondence between a cluster of pixels in the region of interest and a particular crop type based on known features of this particular crop type at this growth stage. More specifically, the system can input the current date or time of year into a crop identification model in order to calculate a strength of correspondence—between a cluster of pixels and a particular crop type—that addresses changes in sizes and emission spectra (e.g., colors) of a crop throughout its growth cycle.

Alternatively, the system can select and implement a temporal crop identification model—tailored to a certain subset of the growth stage of a particular crop type and configured to identify a particular crop within a particular stage of growth—based on the current date, time of year, or growth season in the geographic region in which the farm is located.

### 7.1 Selective Crop Type Checks: Common Crops

As shown in FIGS. 1 and 3, the system can also access or compile a list of crops commonly planted in the geographic region and leverage this list of crops to prioritize crop types tested in the region of interest of the satellite image. In particular, the system can test features extracted from the region of interest of the satellite image against crop identification models for a small number of crop types that have historically been grown on the farm, within the greater geographic region, and/or sold at a market near the farm or in the geographic region, as these historical data may be strong indicators of crops likely to be currently planted on the farm. For example, the system can: access market data for commodities originating in regions throughout the world and results of analyses of satellite images performed by the system over time to detect crops planted throughout the world to construct a global (or regional) map of crops planted throughout the world; and refine this crop map over time pending new commodities data and crop analyses of satellite images responsive to new loan applications. Upon receipt of a request to analyze the loan application for the farmer, as described above, the system can query this crop map for types of crops commonly grown in this geographic region in which the farmer's property is located. The system can then: retrieve crop identification models constructed to identify each of these crops; and test features extracted from the region of interest in the satellite image (or pixels in the region of interest in the satellite image labeled as representing plant matter, as described above) against these crop identification models to determine whether pixels in this region of interest are likely to represent any of these crops common to this geographic region. In this example, the system can also: rank crop identification models for crops grown in the geographic region by frequency or by total land area in which these crops are historically planted in the geographic region; test a cluster of features extracted from a region of interest in the satellite image for strength of correspondence to these crop identification models—in order of rank of the corresponding crop in the geographic region—until a strong match is found. In particular, once the system identifies a strength of correspondence—between a cluster of features extracted from the region of interest in the satellite image and a particular crop identification model in the ranked set of models—that exceeds a preset threshold, the system can label a corresponding cluster of pixels in the satellite image with the type of crop represented by this particular crop identification model.

Similarly, the system can: generate a list of crops common to the geographic region, such as based on crops detected in satellite images of the geographic region over a previous period of time; retrieve a set of crop identification models, each configured to detect one crop in this list of crops; compare a cluster of pixels—in the region of interest in the satellite image labeled as likely to represent a crop—to the set of crop identification models; and then detect the first crop present on the first farm in Block S130 based on a match between features extracted from the cluster of pixels and a particular crop identification model corresponding to the particular crop.

The system can repeat this process for each other cluster of features extracted from the satellite image in order to identify one or more crops on the farm and a distribution of this crop(s) throughout the farm. The system can therefore access and implement contextual crop data for the geographic region in which the farm is located in order to intelligently check the region of interest in the satellite image for certain crops likely to be planted on the farm and to thus reduce a time and processing power necessary for the system to identify one or more crops planted on the farm.

### 7.2 Selective Crop Type Checks: Farmer-Specified Crops

In the implementation described above in which the loan officer or the farmer enters a particular type of crop(s) planted on the farm into the electronic form or otherwise supplies crop information to the system, the system can prioritize testing features extracted from regions of interest against a crop identification model for this particular type of crop in order to confirm that this crop is planted on the farm. In particular, the system can: extract a list of crops grown on the farm from the loan application in Block Silo; retrieve a set of crop identification models, wherein each crop identification model in the set of crop identification models is configured to detect one crop type in the list of crops; compare a cluster of pixels—in the region of interest in the satellite image labeled as likely to represent a crop—to the set of crop identification models; and then confirm a particular crop type—in the list of crops specified in the loan application—present on the farm in Block S130 based on a match between features extracted from the cluster of pixels and a particular crop identification model corresponding to the particular plant.

The system can repeat the foregoing methods and techniques for each pixel or cluster of pixels in the region of interest in the satellite image until the system has labeled each pixel in the region of interest as one of: manmade (e.g., a dwelling, a vehicle, a road); geological (e.g., undeveloped earth); a plant of a particular crop type; or unknown. The system can thus estimate object and crop types located throughout the farm at a resolution of one pixel (or at a resolution of a small cluster of pixels) of the farm represented in the satellite image.

### 7.3 Manual Crop Labeling

Furthermore, if the system is unable to identify a crop in the region of interest of the satellite image, the system can serve the region of interest in the satellite image back to the loan officer and prompt the loan officer to manually label areas in the region of interest thus labeled by the system as “unknown.” For example, the system can return this region of interest to the loan officer in near real-time—via the web browser or native application executing on the loan officer's computing device—during the loan application process (i.e., as the loan officer and/or the farmer populate the loan application form with various information). Alternatively, the system can serve the region of interest in the satellite image to another human annotator for manual identification of areas or pixel clusters labeled by the system as “unknown.”

However, the system can implement any other computer vision, artificial intelligence or other automated methods or techniques to determine which crop(s) is planted on farm based on data extracted from a recent satellite image of a geographic region in which the farm is located.

### 7.4 Crop Area

Once the system identifies and distinguishes one or more clusters of pixels in the satellite image as one or more unique crop types present on the farm, the system can: label these pixels accordingly; and transform pixels clusters labeled with particular crop types in the satellite image into land area of which these crops are planted on the farm. For example, the system can leverage a crop identification model described above to identify and label a cluster of pixels in the region of interest in the satellite image as likely to represent a particular crop; count the number of pixels in this cluster; and multiply this pixel count by a scalar value (e.g., a pixel area to land area conversion value received within the satellite image) in order to estimate a land area of the particular crop planted on the farm.

The system can repeat this process for each other unique crop type detected in the region of interest in the satellite image, as shown in FIG. 1. However, the system can implement any other method or technique to estimate the land area of a particular crop planted on the farm.

### 8. Yield

Block S134 of the method S100 recites, estimating a first yield per unit land area of the first crop present on the first farm based on the first set of features. Generally, in Block S134, the system can predict a final yield per unit land area planted (or a final yield) of the particular crop at the farm based on features detected in the region of interest in Block S122.

In one implementation shown in FIG. 1, the system passes the region of interest into a yield model to transform these optical data into a prediction of yield per unit land area of crops planted at the farm. (More specifically, the system can pass a cluster of pixels—in the region of interest in the satellite image and labeled as likely to represent a particular crop—through the yield model to estimate a yield per unit land area of the particular crop on the first farm.) For example, the yield model can include a convolutional neural network trained on historical satellite images labeled with ground truth yield data for a particular crop and configured to output a yield prediction per unit land area planted for the particular crop. The system can thus: extract a cluster of pixels in the region of interest in the satellite image identified as likely to represent the particular crop in Block S122; pass these pixels into the yield model to predict final yield of the particular crop per unit land area planted in Block S134; and multiply this predicted final yield of the particular crop per unit land area planted by the estimated area of the particular crop planted to thus predict a final yield of the crop from the farm at time of harvest based on current optical data (i.e., a satellite image) of the farm.

Alternatively, the yield model can include a convolutional neural network trained on historical satellite images labeled with ground truth yield data for a variety of crops and configured to output a yield prediction per unit land area planted for these crops. The system can thus: pass the region of interest in the satellite image into the yield model to predict final yield per unit land area planted for various crops planted on this farm in Block S134 and then segment these yield predictions across the farm based on crop type identified in Block S130.

However, the system can implement any other method or techniques to predict or estimate final yield or final yield per unit land area planted for one or more crops present on the farm in Block S134 based on current optical data available for the farm.

### 8.1 Other Crop and Farm Qualities

The system can additionally or alternatively implement one or more crop quality models to derive qualities of crops and/or soil on the farm from the region of interest in the satellite image. For example, the system can implement computer vision and/or artificial intelligence techniques to estimate current water stress in the crop, pest pressure (and particular types of pest) in the crop, soil quality (e.g., nutrient content, fertilizer presence) of the soil in which the crop is planted, and/or moisture content in this soil; etc.

The system can also extract these metrics from a series of satellite images recorded over a preceding period of time to derive crop and soil quality trends at the farm.

### 9. Landmark Proximity

In one variation shown in FIG. 3, the system can also leverage the satellite image and/or other external data to estimate or calculate proximity of the farm to various landmarks, such as a market, paved roads, or water.

### 9.1 Roads and Local Market

In one implementation shown in FIG. 1, once the system accesses the location of the farm, as described above, the system can query a market or map database for a location of a local market nearest the farm. Once the location of the local market is received, the system can query a map database for a paved road or route extending from the local market to a landmark proximal the farm. Additionally or alternatively, if road data is not available for some or all of this geographic region, the system can implement a road detection model to detect paved and unpaved roads; the system can then identify a route along paved and/or unpaved roads between the local market and the farm. For example, the system can implement a convolution neural network trained to detect paved and unpaved roads in satellite images in order to scan the satellite image for a road running from the local market to proximal the farm. The system can then calculate an onroad distance, an offroad distance, and/or a total distance from the farm to the local market.

Generally, proximity of the farm to a local market and the quality of roads between the farm and this local market may affect the total amount of the crop that the farmer may transport from the farm to the market at a given time and/or a speed with which the farmer may transport this crop from the farm to the market, which may in turn affect the quality of the crop and thus the market price that the farmer receives for this crop and the farmer's total revenue for this crop. Therefore, in one implementation, the system can refine the crop yield prediction for the farm based on these onroad and offroad distances between the farm and the local market. For example, the system can calculate a transport-related yield correction coefficient that is inversely proportional to the onroad and offroad distances between the farm and the local market (i.e., that decreases with increasing onroad and offroad distances). In this example, because moving crops may be more difficult over unpaved roads than over paved roads, the system can also assign greater weight to the offroad distance than to the onroad distance and thus reduce the transport-related yield correction coefficient at a greater rate per offroad distance unit than per onroad distance unit

The system can additionally or alternatively estimate a cost to transport the crop from the farm to the local market based on these onroad and offroad distances and then incorporate this estimated transportation cost into the total cost estimate and/or the productivity estimate described below.

### 9.2 Water

Similarly, the system can: query a map database for a fresh water supply near the farm, such as a river, stream, or lake; or implement computer vision techniques and a water model to detect a body of standing or moving fresh water in the satellite image. The system can then: calculate a distance from this water supply to the farm estimate a water transportation cost based on this distance and incorporate this estimated transportation cost into the total cost estimate and/or the productivity estimate described below.

Furthermore, if the system determines that the location of the farm falls in an arid area or in an area with underdeveloped access to groundwater (e.g., aquifer), the system can also calculate a water-related yield correction coefficient as an inverse function of distance to this body of fresh water and as a function of water level in this body of water such that the loan risk score calculated in Block S140 compensates for increased water transportation time and/or reduced water access at the farm, which may impact the farmer's ability to timely and sufficiently irrigate the farm.

### 10. Revenue, Cost, Margin, and Productivity Ratio

Block S136 recites accessing a first production cost per unit land area of the first crop planted and a first market price of the first crop in the geographic region; and Block S142 recites estimating a first productivity score of the first farm based on the first yield per unit land area, the first production cost per unit land area, the first market price, and the first land area of the first crop present on the first farm. Generally, in Block S136, the system retrieves market-related data from an external source, such as average or typical production costs for crops in the geographic region and current or forecast market prices for crops in the geographic region or at the local market more specifically. In Block S142, the system can then leverage these data with metrics extracted from the satellite image to forecast a productivity of the farm, as shown in FIG. 1.

In one implementation, the system: retrieves a current market price of the crop in the geographic region, such as from a local or global agricultural marketplace database; and calculates the product of the predicted yield per unit land area of the crop planted at the farm (i.e., as derived from the satellite image), the land area of the crop planted at the farm, and the current market price of the crop in order to estimate total revenue from this crop at the farm for the current crop season. (Alternatively, the system can forecast the market price of the crop in the geographic region at or near the time of harvest based on historical market data for the geographic region during previous harvest periods.)

Similarly, the system can: access historical production costs per crop unit (e.g., currency amount per hectare planted) for the crop in the geographic region; and calculate a product of this production cost per crop unit and the total area of the crop planted on the farm to estimate total production cost for this crop at the farm for the current crop season. For example, the system can query an agricultural almanac database for a first production cost per unit land area of the first crop planted in the geographic region in Block S136.

The system can then automatically calculate a productivity (or “output-input ratio”) for the crop grown on the farm by dividing the estimated total revenue for the crop by the estimated total cost to produce this amount of the crop in Block S142. The system can therefore: extract an estimated total yield for the crop from the farm from the satellite image (e.g., a product of an estimated yield per unit and estimate total area planted for the crop, both derived from the satellite image); and merge this estimated total yield with costing and market data accessed from external sources to predict financial input and financial outcomes for this crop at the farm.

The system can repeat the foregoing process for other crops detected on the farm to calculate a productivity metric for each crop. The system can additionally or alternatively aggregate these productivity metrics into one composite productivity metric for the farm for the current crop season.

### 11. Insufficient Current Crop Data

In one variation, if insufficient crop data for the farm is currently available, the system can implement the foregoing methods and techniques to predict yield, revenue, margin, and/or an input-output ratio for the farm during the preceding crop season. For example, the farmer may submit the foregoing loan applications early in the current crop season such that no crops are currently present in fields at the farm or such that foliage density of planted crops is too low for detection or accurate assessment in a satellite image.

Therefore, if the system (or a crop detection model, etc.) is unable to detect foliage in the region of interest of the satellite image corresponding to the farm, the system can: query the database of satellite images for satellite images recorded around a time of last harvest—such as last harvest of the crop specified in the loan application—in the geographic region; isolate the same region of interest corresponding to the farm in these satellite images; and identify a most-recent of these historical satellite images that depicts foliage in the region of interest (i.e., an historical satellite image of the farm nearest harvest during the preceding crop season). The system can then analyze this historical satellite image according to methods and techniques described above to: identify a crop planted on the farm; determine a total land area of the crop planted on the farm; estimate a quality of this crop just prior to the preceding harvest; estimate revenue and margin for this crop based on a local market price for the crop at time the time of harvest during the preceding crop season; and then calculate the input-output ratio for this crop grown on the farm during the preceding crop season.

The system can then leverage these derived crop and farm data for the preceding crop season when calculating a risk score for the loan application, as described below.

Alternatively, the system can: extract geological data indicative of ground fertility on the farm from the region of interest in the satellite image; pass the satellite image, the region of interest, or pixels in the region of interest labeled as geological, as described above, into a ground quality model to estimate fertility (and/or aridity, etc.) of land in the geographic region or at the farm specifically; detect crop preparations in the region of interest in the satellite image, such as flatness of the land, signs of tilling (e.g., based on soil color), or presence of crop rows; and predict yield on the farm for the crop specified in the loan application as a function of estimated fertility of the land, flatness of the land, degree of detected tilling, etc.

### 12. Farmer Experience

In another variation, the system can derive a degree of the farmer's experience farming a particular crop detected on the farm. In one implementation, the system: accesses a series of historical satellite images of the geographic region recorded during previous crop seasons; projects the region of interest onto each historical satellite image in the series of historical satellite images; scans the region of interest in each satellite image, in the series of historical satellite images, for the particular crop; and generates a count of previous crop seasons that the particular crop was detected on the farm.

Furthermore, the system can: extract yield data for the crop planted on the farm from historical satellite images recorded just before harvest at the farm, as described above; determine whether these crop seasons were successful based on whether these historical yields exceed preset threshold yields for the geographic region or exceed average yields for the crop throughout the geographic region during these previous crop seasons; and then calculate a total number or a proportion of successful crop seasons for the crop planted at the farm.

The system can then adjust the loan risk score inversely proportional to the count of previous crop seasons—or the proportion of previous successful crop seasons—in which the particular crop was detected on the farm in order to account for the farmer's experience with this particular crop.

### 13. Farmer Skill Level and Farm Robustness

As shown in FIG. 1, the system can similarly predict the farmer's skill level and/or the farm's robustness to weather and climate events based on a comparison of crop features extracted from the region of interest in the satellite image corresponding to farm and crop features extracted from other areas of the satellite image corresponding to other farms in the geographic region. More specifically, differences between predicted yield and crop quality on the farm and predicted yield and crop quality on other farms in the geographic region may indicate: the farmer's skill relative to other farmers in the geographic region; and/or differences in quality or fertility of the land, susceptibility to local flooding, and/or susceptibility to temperature swings, etc. of the farm relative to land throughout the geographic region.

In one implementation, the system: extracts a second set of features from a second region of interest in the satellite image, wherein the second region of interest corresponds to a second land area in the geographic region outside of the farm; identifies the particular crop present in the second land area; predicts a second yield (e.g., an average yield) per unit land area for the particular crop throughout the second land area; and estimates a robustness of the farm as a function of a degree that the yield per unit land area for the particular crop present on the farm exceeds the second yield per unit land area for the particular crop planted in the second land area. The system can then generate or modify the loan risk score inversely proportional to this derived robustness of the farm in Block S140. The system can therefore compare current yield predictions (and/or other crop qualities) in the geographic region to predict the farm's robustness to various weather, pest, and/or other externalities relative to other farms in the geographic region.

In another implementation, the system compares historical yield and crop conditions at the farm to similar features throughout the geographic region to determine whether the farm's or farmer's yield per unit land area of the crop substantially matched, exceeded, or fell below the average yield per unit land area of the crop throughout the geographic region during a preceding crop season. In one example, the system: accesses satellite images of the geographic region during a previous crop season; implements the foregoing method and techniques to detect the crop in the satellite image and to estimate crop yield (e.g., average crop yield) for the crop throughout the geographic region based on features extracted from the satellite image; calculates a difference between the estimated crop yield for the farm and the estimated average crop yield for the geographic region during this previous crop season; and generates a quantitative or qualitative metric that represents the farmers skill and/or the farm's robustness to external effects (e.g., temperature variations, rainfall variations) based on this difference. More specifically, if the system determines low yield for this crop generally throughout the geographic region but crop yield at the farm is moderate or high over the same crop season, the system can predict that the farmer exhibits above-average skill and/or that the farm is more robust (i.e., less susceptible) to external effects. However, if the system determines that crop yield at the farm is less than average in the geographic region during this same crop season, the system can predict that the farmer exhibits below-average skill and/or that the farm is more susceptible to external effects.

In the foregoing example, the system can also repeat this process for additional crop seasons in the geographic region in order to generate a set of values representing differences between crop yield at the farm and crop yield throughout the geographic region. The system can then: extract a trend in crop yield at the farm versus the geographic region generally; and predict the farmer's skill and/or the farm's robustness to external effects—relative to other farmers and/or farms within the geographic region—with greater accuracy based on this trend.

In another implementation, the system queries an historical weather database for weather data that indicate an anomalous weather condition (e.g., temperature and/or rainfall deviations from typical conditions in the geographic region) or a notable pest condition in the geographic region correlated to crop failure during a preceding crop season. The system then: retrieves satellite images of the geographic region during this crop season, such as recorded before this weather or pest condition and at time of harvest; estimates crop yield for the farm and for the geographic region generally in these satellite images; calculates an average impact of the weather or pest condition on pre-condition estimated yield and estimated final yield at time of harvest throughout the geographic region and for the farm specifically; and compares these estimated impacts for the farm and the geographic region generally in order to determine whether the weather or pest condition in the geographic region produced above-average, average, or below-average yield loss at the farm relative to other farms in the geographic region. The system can then predict that the farmer is less-skilled, of average skill, or more-skilled than other farmers in the geographic region, respectively, and/or that the farm is less, similarly, or more robust than the geographic region generally, respectively.

In the foregoing implementations, the system can additionally or alternatively retrieve ground truth historical crop yield data for the geographic region—and for the farm more specifically—from other sources or databases, such as a local crop yield database or local tax records. The system can then implement similar methods and techniques to predict the farmer's skill level and/or the robustness of the farm.

### 14. Weather Effects

In one variation, the system can also query a weather database for a longer-term weather forecast for the geographic region and estimate weather-related risk to the crop throughout the geographic region according to this forecast. For example, the system can: query historical weather data for the geographic region; extract final yield data for the crop in past crop seasons within the geographic region from historical satellite images of the geographic region or retrieve ground truth crop yield data from another database; and then train a weather-yield model on these final yield data and related weather data to configure the weather yield model to output a weather-related yield correction coefficient that predicts crop loss based on forecast weather conditions. (The system can also train the weather-yield model on yield and weather data from a greater geographic area or from worldwide data.) The system can then inject forecast weather conditions for the geographic region into the weather yield model to calculate the weather-related yield correction coefficient for the geographic region or for the farm more specifically. This system can thus predict crop loss at the farm based on forecast local weather conditions.

In another implementation, the system can derive a measure of the farmer's skill and/or a robustness of the farm to certain anomalous weather conditions, such as described above. The system can then predict a degree of crop loss due to certain forecast weather conditions in the geographic region based on this measure of the farmer's skill and/or robustness of the farm to such weather conditions and calculate the weather-related yield correction coefficient for the farm according to this predicted degree of crop loss for the current crop season.

### 15. Intent

In one variation shown in FIG. 3, the system can also predict the farmer's intent to repay a new loan based on both the farmer's loan repayment history and the historical crop conditions in the geographic region, which may have directly affected the farmer's ability to repay past loans.

In one implementation, the system: retrieves a loan history associated with the farm or farmer; identifies, in the loan history, a loan default occurrence during a previous crop season; retrieves a second satellite image recorded during the previous crop season (e.g., just before harvest during the previous crop season) from the satellite image database; extracts a second set of features from this second satellite image; and then identifies a particular crop present throughout the geographic region, estimates a second yield per unit land area of the particular crop present on the farm, and estimates an average yield per unit land area of the particular crop throughout the geographic region based on the second set of features. If the second yield per unit land area of the particular crop planted on the farm during the preceding crop season is less than a crop failure threshold (e.g., 50% of historical yield per unit land area for the particular crop in the geographic region), the system can associate this past loan default with crop failure at the farm during this previous crop season (i.e., the system can predict that crop failure at the farm led to loan default by the farmer). Furthermore, if the system determines that the average yield per unit land area throughout the geographic region during this same crop season is also less than the crop failure threshold, the system can: determine that many or most farms in the area experienced such crop failure, such as due to local weather events during the crop season; predict less farmer responsibility for this crop failure; and thus reduce the loan risk score or otherwise not increase the loan risk score for the farmer in Block S140 despite this loan default history.

However, if the system determines that the average yield per unit land area throughout the geographic region during this same crop season is (significantly) greater than the crop failure threshold, the system can: determine that crop failure at the farm during the previous crop season was anomalous; predict below-average farmer skill and/or farm robustness; and thus increase the loan risk for the farmer in Block S140 due to such low farmer skill and/or low farm robustness. Also, if the system determines that the yield per unit land area at the farm was (significantly) greater than the crop failure threshold, the system can: predict that farm achieved sufficient yield during the previous crop season to produce profit sufficient to repay some or all of the loan; and then calculate a significantly increased loan risk score for the farmer accordingly in Block S140.

Therefore, by comparing yield predictions for the farm and other farms in the geographic region during a previous crop season in which the farmer defaulted on a loan, the system can predict a reason for this default and predict an intent of the farmer to repay past and future loans accordingly.

The system can additionally or alternatively retrieve ground truth historical crop yield data for the geographic region—and for the farm more specifically—from other sources or databases, such as a local crop yield database or local tax records. The system can then implement similar methods and techniques to predict a reason for a past loan default and to predict an intent of the farmer to repay past and future loans based on these other data in Block S140.

### 16. Other Crops

In one variation in which the farmer or the loan officer indicates that multiple crop types are planted on the farm and/or in which the system detects multiple unique crop types on the farm in Block S130, the system can implement the foregoing methods and techniques to estimate a total planted area, a final yield, a total revenue, a total production cost, productivity, farmer skill, and/or farm robustness, etc. for each of these crops present on the farm, as shown in FIG. 1.

For example, in addition to the processes described above, the system can also: pass the region of interest in the satellite image through a second crop identification model to detect a second cluster of pixels in the region of interest likely to represent a second crop in Block S130; scale an area of the second cluster of pixels to estimate a second land area of the second crop present on the farm in Block S132; pass the second cluster of pixels through the yield model described above to estimate a second yield per unit land area of the second crop present on the farm in Block S134; access a second production cost per unit land area of the second crop planted and a second market price of the second crop in the geographic region in Block S136; estimate a second productivity score of the first farm based on the first yield per unit land area, the second production cost per unit land area, the second market price, and the second land area of the second crop present on the first farm in Block S142; and generate a loan risk score for the farm based on a first productivity score for a first crop planted on the farm, the second productivity score for the second crop, and various other metrics extracted from remote sensing data—such as relative to a proposed loan amount indicated in the loan application—in Block S140 described above. The system can then return the loan risk score, the first productivity score, and the second productivity score to a computing device affiliated with a lender.

### 17. Loan Risk Score

Block S140 of the method S100 recites generating a loan risk score for the first loan application. Generally, in Block S140, the system can compile the foregoing data—extracted from one or more satellite images of the geographic region in which the farm is located and/or retrieved from other remote sensing databases—into a loan risk score that accounts for crop conditions at the farmer's farm, crop and market conditions in this geographic region, farmer and farm histories, farmer intent, etc., all of which may impact the farmer's capacity to timely repay a loan issued by the lender. For example, the system can compile the foregoing data in Block S140 to generate quantitative value that represents the creditworthiness of a borrower whose sole or primary source of income is agriculture-related and that therefore accounts for agricultural conditions in and area of the borrower's farm.

In one implementation shown in FIG. 1, the system generates the risk score containing weighted or binary values representing the foregoing derived data. For example, the system can calculate the risk score: as a function of estimated yield from the farm or including a binary value (e.g., “1” or “0”) based on whether the estimated yield from the farm exceeds a threshold yield (e.g., an absolute preset threshold yield per unit land area for the crop or 80% of the average predicted yield in the geographic region for the current crop season); as a function of the estimated productivity of the farm or including a binary value based on whether the estimated productivity exceeds a preset threshold value; as a function of a ratio of productivity of the farm to requested loan amount or including a binary value based on whether this ratio exceeds a preset threshold (e.g., 150%); as an inverse function of yield correction coefficients (which may represent measures of various weather-related, transport-related, water-related, and/or risks to the crop before and after harvest) or including a binary value based on whether the sum of the yield correction coefficients is less than a threshold risk value; as a function of diversification of crop types planted on the farm (e.g., deviation from a target number of three unique crops planted on the farm) or including a binary value based on whether the number of crop types planted on the farm falls within a target range (e.g., two, three, or four unique crops types planted per farm); as an inverse function of distance to a local market or including a binary value based on whether the farm is located at a distance less than a threshold distance to a local market; as a function of estimated farmer skill level or including a binary value based on whether estimated farmer skill level exceeds a threshold skill level (e.g., an absolute preset threshold skill level or a relative threshold skill level for the geographic region); as a function of farmer experience growing the crop or including a binary value based on whether the farmer previously planted the crop for at least a threshold number of crop seasons; as a function of estimated farm robustness or including a binary value based on whether estimated farm robustness for the farm exceeds a threshold farm robustness; and/or as an inverse function of degree of responsibility of the farmer for defaulting on a previous loan or including a binary value based on whether a past loan default by the farmer is correlated with a comprehensive crop failure in the geographic region or perceived intent to avoid loan repayment.

The system can also adjust the loan risk score: inversely proportional to water stress in the crop at the farm; inversely proportional pest pressure in the crop; proportional to soil quality (e.g., nutrient content, fertilizer presence) of the soil in which the crop is planted; inversely proportional to a difference between estimated moisture content and a target moisture content in this soil; etc.

In the foregoing example, the system can thus generate a crop risk score that falls within a minimum score of “0” and a maximum score of “60” (or “100,” or “800,” etc.). However, the system can generate a crop risk score in any other way and based on any other data collected or derived by the system in Blocks S130, S132, S134, S136, and S142.

### 18. Loan Analysis Feedback

Block S150 of the method S100 recites returning the loan risk score and the first productivity score to the user at approximately the first time. Generally, in Block S150, the system can return the loan risk score and/or the predicted productivity for the farm to the loan officer (or to another associate of the lender), such as via the lender portal in near real-time following receipt of loan application data from the loan officer in Block S110.

For example, the system can: execute the foregoing processes immediately upon receipt of loan application data from the loan officer via the lender portal; and then return the loan risk score and the predicted productivity of the farm—in the form of two quantitative values—to the lender portal within two minutes of receipt of these loan application data.

However, the system can return the loan risk score and the predicted productivity for the farm to the loan officer or other associate of the lender in any other way in Block S150.

### 19. Post-Lending: Satellite Image Monitoring

In one variation, the method S100 further includes: in response to confirmation of the first loan application by a lender, accessing a second series of satellite images representing the geographic region and recorded over a second period of time succeeding the first time in Block S120; for each satellite image in the second series of satellite images, extracting a second set of features from a second region of interest—corresponding to the farm—in the second satellite image in Block S122, generating a second estimated yield of the crop present on the farm based on the second set of features in Block S134, and generating a first crop risk score for the farm in Block S160; and, in response to the first crop risk score exceeding a threshold score, serving a prompt to the lender to selectively contact a farmer associated with the first farm in Block S152.

Generally, in this variation, if the loan officer accepts the loan application and issues a loan to the farmer, such as based on the loan risk score and the predicted productivity served by the system to the lender portal in Block S150, the loan officer can enter confirmation of this loan to the farmer into the lender portal. The system can access this loan confirmation and flag the farm for subsequent monitoring in order to detect local conditions that may affect the farmer's capacity to repay the loan at the conclusion of the crop season. In particular, once the loan officer or other associate of the lender confirms acceptance of the loan application (and issuance of a loan to the farmer), the system can: monitor the farm according to the foregoing methods and techniques through the remainder of the crop season; identity changes in the farm or geographic region more generally that may indicate reduction in crop yield and/or reduction in productivity; and selectively the prompt the loan officer or other associate of the lender to serve educational guidance, physical assistance, additional loan capital, and/or other support to the farmer when such adverse changes are detected, thereby enabling the lender to efficiently and proactively distribute its resources in order to support its customers and reduce risk of default on its outstanding loans.

### 19.1 Crop Risk Score and Individual Prompts

In one implementation, once the loan is confirmed and assigned to the system for monitoring, the system regularly queries the satellite image database for a new satellite image representing a geographic region in which the farm is located. Upon receipt of a new satellite image containing a representation of the farm, the system can: extract the region of interest from this new satellite image; and pass this region of interest into the yield model described above to refine the predicted crop yield at the farm. (Similarly, the system can implement the crop identification model described above to extract a subset of pixels corresponding to the crop from this new satellite image and then pass this subset of pixels into the yield model to refine the predicted yield for this crop at the farm, as described above.) The system can also: estimate current total planted area of the crop in this satellite image; calculate a new productivity estimate based on the current estimated yield, the current estimated total planted area of the crop, current production costs estimates, and current or forecast market prices for the crop. The system can then calculate an absolute crop risk score, which may predict risk of loan repayment: proportional to predicted yield; proportional to estimated crop area planted; and/or proportional to estimated productivity of the farm.

If this absolute crop risk for the farm (or a product of the absolute crop risk score and the magnitude of the loan associated with the farm) exceeds a preset threshold, the system can then serve a prompt to the loan officer (or to a loan manager or other associate of the lender) to contact the farmer and to provide support to the farmer in Block S160 in order to reduce costs, increase yield, or otherwise reduce crop risk. For example, the system can implement a preset static threshold set by the lender or a dynamic threshold that decreases with time to harvest.

Alternatively, based on the loan risk score, the loan officer may withhold a next installment (or “traunch”) of the loan to the farm. The system can also enable the loan officer to provide specific reasons for this withholding—such as in the form of farm and crop metrics extracted from the current satellite image by the system—to the farmer, which may improve transparency between the lender and the farmer and enable the farmer to intelligently address features of the farm that are affecting his ability to access lending capital.

(The system can implement similar methods and techniques to calculate a relative risk score for the farm or farmer within the geographic region and to respond to this relative risk score, such as if less than a threshold.)

As described above, the system can also extract various crop metrics (e.g., predicted yield, yield per planted area unit, revenue, productivity) from other farms or planted areas throughout the geographic region—detected in the satellite image—and compare crop metrics to like metrics for the farm to determine whether the farm is performing above, below, or comparably to other farms in the geographic region. The system can then generate a relative crop risk score that represents the crop risk for the farm relative to crop risk of other farms in the geographic region

Additionally or alternatively, if the absolute crop risk of the farm exceeds a threshold score, the system can predict a cause of the increased risk. For example, if the absolute crop risk for the farm is high but the relative crop risk for the farm—that is, relative to other farms in the geographic region—is low, the system can: predict that local weather or other external factors are contributing to increased crop risk for the farm; and then serve a prompt to the loan officer (or to the loan manager, to the lender) to connect the farm with resources for managing such external factors. However, if the absolute crop risk for the farm is high and the relative crop risk for the farm is also high, the system can: predict that farmer error is a significant contributing factor to increased crop risk for the farm; and then serve a prompt to the loan officer (or to loan manager, to the lender) to connect the farm with educational or agricultural best practices resources.

In a similar implementation, during a period of time succeeding issuance of a loan to the farmer, the system can: access a series of satellite images of the geographic region, such as recorded on intervals of less than two weeks; estimate a current yield per unit land area planted from the farm based on a current satellite image; and then serve a prompt to the lender to contact the farmer in Block S160 if the current yield per unit land area falls below the first estimated yield per unit land area for the farm—calculated during the loan application process—by more than a threshold crop loss (e.g., 20%) for the crop.

In another implementation, the system can: access a time series of satellite images (e.g., a series of satellite images recorded on a one-week interval) from a satellite image database, as described; and implement methods and techniques described above to identify a type and to estimate a planted area of a crop in the most-recent satellite image. The system can also extract plant quality metrics from the most-recent satellite image, such as including: individual or average plant size; viability of the crop as a whole or sub-blocks of the crop; and/or the growth stage of the crop as a whole or sub-blocks of the crop. The system can therefore qualify or quantify the current state of the crop on the farm based on features extracted from this most-recent satellite image. The system can implement similar methods and techniques to identity the crop, estimate a planted crop area, and extract plant quality metrics—including plant size, plant viability, and/or plant growth stage—from each other satellite image in the time series of satellite images. The system can then calculate: a rate of change in planted crop area; a rate of change in plant size; a rate of change in crop viability; and/or a rate of progress toward harvest; etc. for the crop based on crop metrics extracted from this series of satellite images and timestamps of these satellite images.

Based on these rates of change, the system can quantify progress of the crop growing on the farm, which may indicate a viability of the crop, predict yield of the crop at time of harvest, and/or anticipate crop risk (e.g., a probability of crop failure). For example, the system can estimate yield from the area of planted crop at the time of harvest or estimate a probability that the entire planted crop area will yield saleable plants at time of harvest: as a function of a similarity of the current state of the crop at its current growth stage to a predefined “target” or “model” crop of the same type at this same growth stage; as an inverse function of a deviation of the current state of the crop at its current growth stage from a predefined “target” or “model” crop of the same type at this same growth stage; and/or as an inverse function of a deviation of trends in planted crop area, plant size, and/or plant viability of the crop from corresponding trends of a “target” or “model” crop of the same type. In another example, the system can estimate a probability that the planted crop area on the farm—detected in the most-recent satellite image—will yield salable or viable plants: proportional to a rate of positive progression of the crop; and/or inversely proportional to deviation of the rate of progression of the crop from a “target” or “model” crop of the same type. The system can then compile these metrics to revise a prediction of the yield of the crop from the farm at time of harvest and calculate a crop risk score accordingly. The system can also predict an increased crop risk as a function of a rate of decrease in the planted area of the crop prior to a time or growth stage at which the crop is typically harvested.

However, the system can implement any other methods or techniques to generate and refine a crop risk score from features extracted from new satellite images of the geographic region as these new satellite images become available over time. The system can then selectively prompt an associate of the lender to take an action related to the farm based on this crop risk score in Block S170.

### 19.2 Crop Risk Score Rankings

The system can implement the foregoing methods and techniques to calculate current crop risk scores for other farms associated with outstanding loans issued by the lender. The system can then rank these farms (or the corresponding loans) by their crop risk scores—such as weighted by loan amount issued to these farms—and then serve this ranked list of farms (or loans) to an associate of the lender. The associate of the lender (e.g., the loan officer or another loan manager) can then prioritize remote and in-person support for its farming customers based on this ranked list.

For example, in response to receiving confirmation of issuance of a first loan by the lender to the farm, the system can append a list of loans—issued to farms within the geographic region by the lender—with details of the first loan. Over a subsequent period of time (e.g., during the current crop season in the geographic region), the system can query the satellite image database for satellite images of the geographic region. In response to receipt of a next satellite image of the geographic region from the satellite image database during this period of time in Block S120, the system can then process this new satellite image to derive a crop risk score for each farm in a set of farms associated with a loan in the list of loans issued by the lender. In particular, for each farm in this list, the system can: extract a second set of features from a region of interest in the next satellite image corresponding to the farm; detect a crop present on the farm based on the second set of features; estimate a yield per unit land area of the crop present on the farm based on the second set of features; and estimate a crop risk for the farm inversely proportional to the yield per unit land area of the crop and proportional to a loan amount issued to the farm. The system can then serve a list of this set of farms—ranked by crop risk—for targeted support to the lender in Block S110.

### 19.3 Group Risk Mitigation

In yet another implementation, the system can: calculate a distribution of loans issued to by the lender to farms throughout the geographic region and weighted by crop risk score and loan amount; isolate a subregion containing the highest density of at-risk farms holding loans issued by the lender; and then prompt the lender to dispatch remote or in-person support to this subregion in order to reduce default risk for these loans. For example, in response to receipt of a next satellite image of the geographic region from the satellite image database, the system can: extract a second set of features from a region of interest in the next satellite image corresponding to a farm in the ground electrode; detect a crop present on the farm based on the second set of features; estimate a yield per unit land area of the crop present on the farm based on the second set of features; estimate a crop risk for the farm inversely proportional to the yield per unit land area of the crop and proportional to a loan amount issued to the farm; and repeat this process for each other farm—in a set of farms associated with a loan issued by the lender—in this geographic region. The system can then: isolate a subregion of the geographic region containing a highest density of farms—in this set of farms—weighted by crop risks; and serve—to the lender—a prompt to dispatch agricultural support to this subregion of the geographic region in Block S160.

Once this subregion is identified, the system can also implement a soil moisture model to derive soil moisture content in this subregion based on features extracted from a region of interest in this current satellite image corresponding to this subregion. In Block S160, if soil moisture throughout this subregion is significantly less than an average soil moisture for this geographic region or is significantly less than a target soil moisture for the crop planted, the system can: prompt the lender to dispatch a water expert to the subregion to provide water management guidance to these farmers; or prompt the lender to provide loan supplements to these farmers in order to enable these farmers to acquire more water or install new wells.

The system can similarly implement a pest model to predict pest pressures in this subregion based on features detected in a region of interest of the current satellite image corresponding to this subregion. In Block S160, if this predicted pest pressure exceeds a threshold value across this subregion, the system can: prompt the lender to dispatch a pest expert to the subregion to provide pest management guidance to these farmers; or prompt the lender to provide loan supplements to these farmers to acquire pesticide or herbicides for their crops.

Therefore, for a geographic region in which the lender issues agricultural loans or otherwise holds outstanding agricultural loans, the system can isolate a subregion in which farms that have received loans from the lender are exhibiting greater crop risk—such as weighted by loan amount—than other areas of the geographic region in which the lender operates. The system can then selectively prompt the lender to serve media (e.g., educational content), to dispatch a human expert, and/or to offer supplemental loans in this subregion in order to reduce crop risk in this subregion and thus increase likelihood of loan repayment for the lender in Block S160.

### 19.4 Post-Lending: Weather Monitoring

The system can also monitor weather forecasts throughout the geographic regions for predicted future weather events that may affect crops growing on these farms, such as: low and high temperature peaks; prolonged periods of below- or above-average temperatures; or below- or above-average water fall. The system can then adjust crop risk scores for farms throughout this geographic region based on these forecast weather conditions and then implement the foregoing methods and techniques to selectively prompt the lender to provide preemptive weather-related support or guidance to these farmers in Block S160 in order to reduce crop loss due to such weather conditions.

### 19.5 Harvest Triggers

In another implementation shown in FIG. 3, the system can also serve a prompt to the lender to contact a farmer at or just prior to harvest—such as with revised loan repayment terms—based on data extracted from a current satellite image of the geographic region in order to increase likelihood of timely repayment of the loan by the farmer. For example, for a farm issued a loan by the lender, the system can: monitor growth of the crop by implementing the foregoing methods and techniques to estimate a current growth stage of a crop planted on the farm based on features extracted from a new satellite image of the geographic region in which the farm is located; estimate a time until harvest of the crop at the farm according to the current growth stage of the crop; and repeat this process for each subsequent satellite image of this geographic region recorded. Once this estimated time until harvest for the farm falls below a threshold duration (e.g., five days, or less than a duration between consecutively-recorded satellite images of the geographic region), the system can serve a prompt to the lender to contact the farmer. In this example, the system can prompt the lender to send—to the farmer—an offer of reduced interest rate (e.g., a 1% interest rate reduction) if the outstanding loan is repaid within a limited period of time (e.g., within one week) after harvest. The system can therefore serve timely prompts to the lender to contact the farmer at or near harvest in order to: remind the farmer of the loan; offer incentive to repay the loan soon after sale of the crop yields capital for loan repayment; and thus increase likelihood of loan repayment and shorten time to loan repayment.

In the foregoing implementation, the system can additionally or alternatively: detect that a crop has been harvested on the farm, such as based on a difference between features detected in a region of interest—corresponding to the farm—in a preceding satellite image and features detected in a comparable region of interest in a current satellite image; and then serve a prompt to the lender to contact the farmer, as described above, in Block S160.

However, the system can implement any other method or technique to selectively serve prompts to associates of the lender to contact and support a farm—associated with an outstanding loan held by the lender—based on data extracted from a satellite image of a geographic region in which the farmer's farm is located.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a loan application identifying a first farm and submitted by a user at a first time;
accessing a first satellite image representing a geographic region in which the first farm is located, the first satellite image recorded near the first time;
extracting a first set of features from a first region of interest in the first satellite image, the first region of interest corresponding to the first farm identified by the first loan application;
based on the first set of features:
identifying a first crop present on the first farm;
estimating a first land area of the first crop present on the first farm;
estimating a first yield per unit land area of the first crop present on the first farm; and
generating a loan risk score for the first loan application;
accessing a first production cost per unit land area of the first crop planted and a first market price of the first crop in the geographic region;
estimating a first productivity score of the first farm based on the first yield per unit land area, the first production cost per unit land area, the first market price, and the first land area of the first crop present on the first farm; and
returning the loan risk score and the first productivity score to the user at approximately the first time.

2. The method of claim 1:
wherein accessing the first loan application comprises receiving, from a computing device affiliated with a lender, the first loan application specifying a parcel identifier of the first farm;
wherein accessing the first satellite image comprises:
querying a land database for a geospatial boundary of the first farm based on the parcel identifier; and
querying a satellite image database for the first satellite image encompassing the geographic region containing the geospatial boundary of the first farm and recorded proximal the first time; and
wherein extracting the first set of features from the first region of interest in the first satellite image comprises:
projecting the geospatial boundary of the first farm onto the first satellite image to define the region of interest in the first satellite image; and
extracting the first set of features from the region of interest in the first satellite image.

3. The method of claim 2:
further comprising:
querying a market database for a location of a local market proximal the geospatial boundary of the first farm;
scanning the first satellite image for a road extending from the local market to proximal the first farm;
calculating distance from the local market to the first farm along the road detected in the first satellite image;
wherein generating the loan risk score for the first loan application comprises generating the loan risk score proportional to the first productivity score of the first farm, inversely proportional to the onroad distance, and inversely proportional to the offroad distance

4. The method of claim 1:
wherein accessing the first market price of the first crop in the geographic region comprises:
querying a market database for a location of a local market proximal a location of the first farm indicated in the first loan application; and
querying a market database for a current market price of the first crop at the local market;
wherein accessing the first production cost per unit land area of the first crop planted in the geographic region comprises querying an agricultural almanac database for a first production cost per unit land area of the first crop planted in the geographic region; and

5. The method of claim 1:
further comprising querying a land database for a geospatial boundary of the first farm identified in the first loan application;
wherein extracting the first set of features from the first region of interest in the first satellite image and identifying the first crop present on the first farm based on the first set of features comprises:
projecting the geospatial boundary of the first farm onto the first satellite image to define the region of interest in the first satellite image; and
passing the region of interest through a first crop identification model to detect a first cluster of pixels in the region of interest likely to represent the first crop;
wherein estimating the first land area of the first crop present on the first farm comprises scaling an area of the first cluster of pixels to estimate the first land area of the first crop present on the first farm; and
wherein estimating the first yield per unit land area of the first crop present on the first farm comprises passing the first cluster of pixels through a yield model to estimate the first yield per unit land area of the first crop present on the first farm.

6. The method of claim 5:
wherein passing the region of interest through the first crop identification model comprises interpreting the first cluster of pixels in the region of interest in the first satellite image as likely to represent the first crop based on the first crop identification model comprising a first neural network trained on satellite images labeled with land areas planted with the first crop; and
wherein passing the first cluster of pixels through the yield model to estimate the first yield per unit land area of the first crop present on the first farm comprises passing the first cluster of pixels through a second neural network, trained on satellite images labeled with ground truth crop yield data for the geographic region, to predict the first yield per unit land area of the first crop present on the first farm.

7. The method of claim 5, wherein identifying the first crop present on the first farm comprises:
generating a list of crops common to the geographic region based on crops detected in satellite images of the geographic region over a period of time preceding the first time;
retrieving a set of crop identification models, each crop identification model in the set of crop identification models configured to detect one crop in the list of crops;
comparing the first cluster of pixels in the region of interest in the first satellite image to crop identification models in the set of crop identification models; and
detecting the first crop present on the first farm based on a match between features extracted from the first cluster of pixels and the first crop identification model, in the set of crop identification models, corresponding to the first crop.

8. The method of claim 5:
wherein accessing the first loan application comprises extracting a list of crops grown on the first farm from the first loan application; and
wherein identifying the first crop present on the first farm comprises:
retrieving a set of crop identification models, each crop identification model in the set of crop identification models configured to detect one crop in the list of crops;
comparing the first cluster of pixels in the region of interest in the first satellite image to crop identification models in the set of crop identification models; and
confirming the first crop, in the list of crops specified in the first loan application, present on the first farm based on a match between features extracted from the first cluster of pixels and the first crop identification model, in the set of crop identification models, corresponding to the first crop.

9. The method of claim 5:
wherein accessing the first loan application comprises extracting a proposed loan amount from the first loan application;
further comprising:
passing the region of interest through a second crop identification model to detect a second cluster of pixels in the region of interest likely to represent a second crop;
scaling an area of the second cluster of pixels to estimate a second land area of the second crop present on the first farm;
passing the second cluster of pixels through the yield model to estimate a second yield per unit land area of the second crop present on the first farm;
accessing a second production cost per unit land area of the second crop planted and a second market price of the second crop in the geographic region; and
estimating a second productivity score of the first farm based on the first yield per unit land area, the second production cost per unit land area, the second market price, and the second land area of the second crop present on the first farm;
wherein generating the loan risk score for the first loan application comprises generating the loan risk score based on the first productivity score and the second productivity score compared to the proposed loan amount; and
wherein returning the loan risk score and the first productivity score to the user comprises serving the loan risk score, the first productivity score, and the second productivity score to a computing device affiliated with a lender.

10. The method of claim 1, wherein generating the loan risk score for the loan application comprises:
retrieving a loan history associated with the first farm;
identifying a loan default in the loan history, the loan default occurring during a previous crop season preceding the first time;
retrieving a second satellite image recorded during the previous crop season;
extracting a second set of features from the second satellite image;
based on the second set of features:
identifying the first crop present throughout the geographic region;
estimating a second yield per unit land area of the first crop present on the first farm; and
estimating an average yield per unit land area of the first crop throughout the geographic region;
in response to the second yield per unit land area falling below a crop failure threshold, associating the loan default with crop failure at the first farm during the previous crop season; and
in response to associating the loan default with crop failure at the first farm and in response to the average yield per unit land area falling below the crop failure threshold, decreasing the loan risk score.

11. The method of claim 1: wherein generating the loan risk score for the first loan application comprises:
retrieving a loan history associated with the first farm;
identifying a loan default in the loan history, the loan default occurring during a previous crop season preceding the first time;
retrieving a second satellite image recorded during the previous crop season;
extracting a second set of features from the second satellite image;
based on the second set of features:
identifying the first crop present throughout the geographic region;
estimating a second land area of the first crop present on the first farm;
estimating a second yield per unit land area of the first crop present on the first farm; and
accessing a second production cost per unit land area of the first crop planted and a second market price of the first crop in the geographic region during the previous crop season;
estimating a second productivity score of the first farm during the previous crop season based on the second yield per unit land area, the second production cost per unit land area, the second market price, and the second land area of the first crop present on the first farm during the previous crop season;
predicting a default intent for the loan default as a function of the second productivity score; and
calculating the loan risk score based on the default intent.

12. The method of claim 1:
further comprising:
extracting a second set of features from a second region of interest in the first satellite image, the second region of interest corresponding to a second land area in the geographic region; and
based on the second set of features:
identifying the first crop present in the second land area; and
predicting a second yield per unit land area for the first crop in the second land area; and
wherein generating the loan risk score for the first loan application comprises:
estimating a robustness of the first farm as a function of a degree that the first yield per unit land area for the first crop present on the first farm exceeds the second yield per unit land area for the first crop planted in the second land area; and
generating the loan risk score inversely proportional to the robustness of the first farm.

13. The method of claim 1, wherein generating the loan risk score for the first loan application comprises:
accessing a series of historical satellite images of the geographic region recorded during previous crop seasons;
projecting the region of interest onto each historical satellite image in the series of historical satellite images;
scanning the region of interest in each satellite image, in the series of historical satellite images, for the first crop;
generating a count of previous crop seasons that the first crop was detected on the first farm; and
generating the loan risk score inversely proportional to the count of previous crop seasons that the first crop was detected on the first farm.

14. The method of claim 1, further comprising:
at a second time succeeding the first time, receiving confirmation of issuance of a loan by a lender to the first farm;
over a period of time succeeding the second time, querying a satellite image database for satellite images of the geographic region;
in response to receipt of a next satellite image of the geographic region from the satellite image database during the period of time:
extracting a second set of features from the next satellite image;
based on the second set of features:
identifying the first crop present on the first farm;
estimating a second land area of the first crop present on the first farm; and
estimating a second yield per unit land area of the first crop present on the first farm;
in response to the second yield per unit land area falling below a threshold yield per unit land area for the first crop, serving a prompt to an associate of the lender to contact a first farmer associated with the first farm.

15. The method of claim 14:
wherein returning the loan risk score and the first productivity score to the user at approximately the first time comprises returning the loan risk score and the first productivity score to the user within two minutes of the first time;
wherein querying the satellite image database for satellite images of the geographic region comprises, during the period of time succeeding the second time, accessing a series of satellite images of the geographic region recorded on intervals of less than two weeks; and
wherein serving the prompt to the associate of the lender to contact the first farmer comprises serving the prompt to the associate of the lender in response to the second yield per unit land area falling below the first yield per unit land area by more than a threshold crop loss for the first crop.

16. The method of claim 1, further comprising:
at a second time succeeding the first time, receiving confirmation of issuance of a first loan by a lender to the first farm;
over a period of time succeeding the second time, querying a satellite image database for satellite images of the geographic region;
in response to receipt of a next satellite image of the geographic region from the satellite image database during the period of time:
extracting a second set of features from the next satellite image;
based on the second set of features:
identifying the first crop present on the first farm;
estimating a growth stage of the first crop present on the first farm; and
predicting a time to harvest for the first crop based on the growth stage;
in response to the time to harvest for the first crop falling below a threshold duration, serving a prompt to an associate of the lender to contact a first farmer, associated with the first farm, to initiate repayment of the first loan.

17. The method of claim 1, further comprising:
in response to receiving confirmation of issuance of a first loan by a lender to the first farm at a second time succeeding the first time, appending a list of loans, issued to farms within the geographic region by the lender, with details of the first loan;
over a period of time succeeding the second time, querying a satellite image database for satellite images of the geographic region;
in response to receipt of a next satellite image of the geographic region from the satellite image database during the period of time:
for each farm in a set of farms associated with a loan in the list of loans:
extracting a second set of features from a region of interest in the next satellite image corresponding to the farm; and
based on the second set of features:
detect a crop present on the farm;
estimating a yield per unit land area of the crop present on the farm; and
estimating a crop risk for the farm inversely proportional to the yield per unit land area of the crop and proportional to a loan amount issued to the farm; and
serving, to a computing device associated with the lender, a list of the set of farms, ranked by crop risk, for targeted support from the lender.

18. The method of claim 1, further comprising:
in response to receiving confirmation of issuance of a first loan by a lender to the first farm at a second time succeeding the first time, appending a list of loans, issued to farms within the geographic region by the lender, with details of the first loan;
over a period of time succeeding the second time, querying a satellite image database for satellite images of the geographic region;
in response to receipt of a next satellite image of the geographic region from the satellite image database during the period of time:
for each farm in a set of farms associated with a loan in the list of loans:
extracting a second set of features from a region of interest in the next satellite image corresponding to the farm; and
based on the second set of features:
detecting a crop present on the farm;
estimating a yield per unit land area of the crop present on the farm; and
estimating a crop risk for the farm inversely proportional to the yield per unit land area of the crop and proportional to a loan amount issued to the farm;
isolating a subregion of the geographic region comprising a highest density of farms, in the set of farms, weighted by crop risks; and
serving, to a computing device associated with the lender, a prompt to dispatch agricultural support to the subregion of the geographic region.

19. A method comprising:
accessing a first loan application identifying a first farm, indicating a first loan amount, and submitted by a user at a first time;
accessing a first satellite image representing a geographic region in which the first farm is located, the first satellite image recorded near the first time;
extracting a first set of features from a first region of interest in the first satellite image, the first region of interest corresponding to the first farm identified by the first loan application;
based on the first set of features:
identifying a first crop present on the first farm; and
estimating a first yield of the first crop present on the first farm;
based on the first crop and the first estimated yield, generating a loan risk score for the first loan application;
returning the loan risk score to the user;
in response to confirmation of the first loan application by a lender:
accessing a second series of satellite image representing the geographic region and recorded over a second period of time succeeding the first time;
for each satellite image in the second series of satellite images:
extracting a second set of features from a second region of interest in the second satellite image, the second region of interest corresponding to the first farm identified by the first loan application;
based on the second set of features, generating a second estimated yield of the first crop present on the first farm; and
generating a first crop risk score for the first farm; and
in response to a first crop risk score exceeding a threshold score, serving a prompt to the lender to selectively contact the first farm.

20. A method comprising:
accessing a loan application identifying a farm and submitted by a user;
accessing a satellite image representing a geographic region in which the farm is located;
extracting a set of features from a region of interest in the satellite image, the region of interest corresponding to the farm identified by the loan application;
based on the set of features:
identifying a crop present on the farm;
estimating a land area of the crop present on the farm; and
estimating a yield per unit land area of the crop present on the farm;
accessing a production cost per unit land area of the crop planted and a market price of the crop in the geographic region;
estimating a productivity score of the farm based on the yield per unit land area, the production cost per unit land area, the market price, and the land area of the crop present on the farm; and
returning the productivity score to the user.
